(19) United States
(12) Patent Application Publication
(10) Pub. No.: US 2020/0306874 A1
(43) Pub. Date: Oct. 1, 2020

(54) FRICTION STIR WELDING TOOL

(71) Applicant: HONDA MOTOR CO., LTD., Tokyo (JP)

(72) Inventors: Keisuke TSUTA, WAKO-SHI (JP); Mitsuru SAYAMA, WAKO-SHI (JP); Akiyoshi MIYAWAKI, WAKO-SHI (JP)

(21) Appl. No.: 16/832,972

(22) Filed: Mar. 27, 2020

(30) Foreign Application Priority Data
Mar. 29, 2019 (JP) 2019-067909

(51) Int. Cl. B23K 20/12

(52) U.S. Cl. CPC B23K 20/1255

(57) ABSTRACT

A friction stir welding tool welds a workpiece by rotating a probe about a rotation axis, and embedding the probe inside the workpiece during rotation of the probe from a front end of the probe to weld the workpiece. A first step and a second step are formed in an outer circumferential surface of the probe in a manner that the probe is narrowed stepwise toward the front end of the probe. A first side surface, a second side surface, and a third side surface are formed in the outer circumferential surface of the probe.

### CROSS-REFERENCE TO RELATED APPLICATION

This application is based upon and claims the benefit of priority from Japanese Patent Application No. 2019-067909 filed on Mar. 29, 2019, the contents of which are incorporated herein by reference.

### BACKGROUND OF THE INVENTION

### Field of the Invention

The present invention relates to a friction stir welding tool which welds a workpiece by rotating a probe about the rotation axis and embedding the probe inside the workpiece during rotation of the probe from a front end of the probe.

### Description of the Related Art

Japanese Laid-Open Patent Publication No. 2008-307606 discloses, in FIG. 2, a friction stir welding tool equipped with a prove having a constant outer diameter over the entire length of the probe.

### SUMMARY OF THE INVENTION

In the above described friction stir welding tool, since no edge (corner) is formed in the outer circumferential surface of the probe, it is not possible to efficiently generate friction heat between the probe and the workpiece. Therefore, the performance of cutting and stirring the workpiece is not sufficient. Under the circumstances, it may not be possible to achieve the suitable welding quality.

The present invention has been made taking such a problem into account, and an object of the present invention is to provide a friction stir welding tool which makes it possible to achieve the suitable welding quality.

According to an aspect of the present invention, a friction stir welding tool is provided. The friction stir welding tool is configured to rotate a probe about a rotation axis, and embed the probe inside a workpiece during rotation of the probe from a front end of the probe to weld the workpiece, wherein a step is formed in an outer circumferential surface of the probe in a manner that the probe is narrowed stepwise toward the front end of the probe.

In the present invention, since the step is formed in the outer circumferential surface of the probe in a manner that the probe is narrowed stepwise toward its front end, it is possible to efficiently generate friction heat between the corner of the step and the workpiece. Further, it is possible to efficiently cut, and stir the workpiece by the corner of the step. Therefore, it is possible to achieve the suitable welding quality.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a view schematically showing overall structure of a friction stir welding system including a friction stir welding tool according to an embodiment of the present invention;

FIG. 2 is a partial perspective view showing the friction stir welding tool;

FIG. 3A is a side view showing the friction stir welding tool in FIG. 2;

FIG. 3B is a view showing the friction stir welding tool in FIG. 2, where the friction stir welding tool is viewed from a front end;

FIG. 4 is a perspective view showing lap welding using the friction stir welding tool shown in FIG. 2;

FIG. 5 is a cross sectional view showing lap welding in FIG. 4;

FIG. 6A is a side view showing a friction stir welding tool including a probe according to a first modified embodiment;

FIG. 6B is a side view showing a friction stir welding tool including a probe according to a second modified embodiment; and

FIG. 7 is a side view showing a friction stir welding tool including a probe according to a third modified embodiment.

### DESCRIPTION OF THE PREFERRED EMBODIMENTS

Hereinafter, preferred embodiments of a friction stir welding tool according to the present invention will be described in relation to a friction stir welding system with reference to the accompanying drawings.

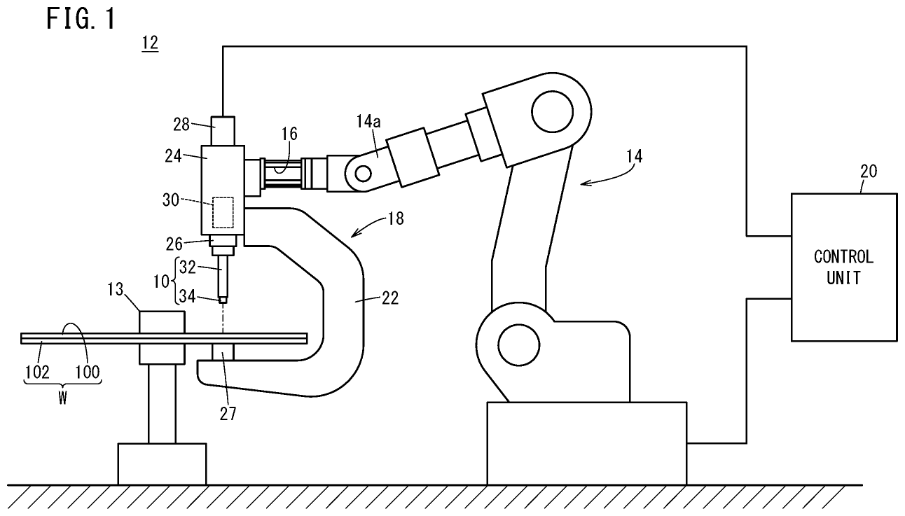

As shown in FIG. 1, a friction stir welding system 12 is configured to perform friction stir welding (FSW) of a workpiece W by, while rotating a friction stir welding tool 10 (hereinafter also referred to as the “welding tool 10”, pressing the friction stir welding tool 10 against the workpiece W.

For example, the workpiece W includes a first member 100 in the form of a plate, and a second member 102 in the form of a plate. In the state where the first member 100 and the second member 102 are stacked together, the workpiece W is fixed to a fixing base 13.

Each of the first member 100 and the second member 102 is made of metal material such as aluminum, magnesium, copper, iron, titanium, or alloy of these materials, etc. The first member 100 and the second member 102 may be made of the same material, or may be made of different materials. It should be noted that at least one of the first member 100 and the second member 102 may be made of resin material. The size and the shape of the first member 100 and the second member 102 may be determined as necessary.

The friction stir welding system 12 includes an industrial multi-joint robot 14, a welding device body 18 provided at a front end of a robot arm 14a of the robot 14 through a connector 16, the welding tool 10 detachably attached to the welding device body 18, and a control unit 20 which controls the entire system totally.

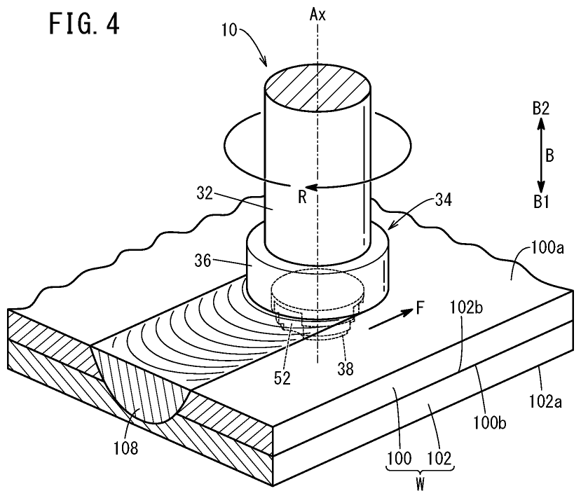

The robot 14 adjusts the position and the orientation of the welding device body 18 relative to the workpiece W to move the welding tool 10 relative to the workpiece W. Specifically, in the case of performing line welding of the workpiece W, the robot 14 adjusts the position and the orientation of the welding device body 18 in a manner that the welding tool 10 moves in a welding direction (in a direction indicated by an arrow F in FIG. 4) relative to the workpiece W. That is, the robot 14 functions as means for moving and tilting the welding tool 10.

The welding device body 18 includes a C-shaped support arm 22, a drive unit 24 provided at one end of the support arm 22, a chuck 26 provided for the drive unit 24 to clamp the welding tool 10, and a receiver member 27 provided at the other end of the support arm 22.

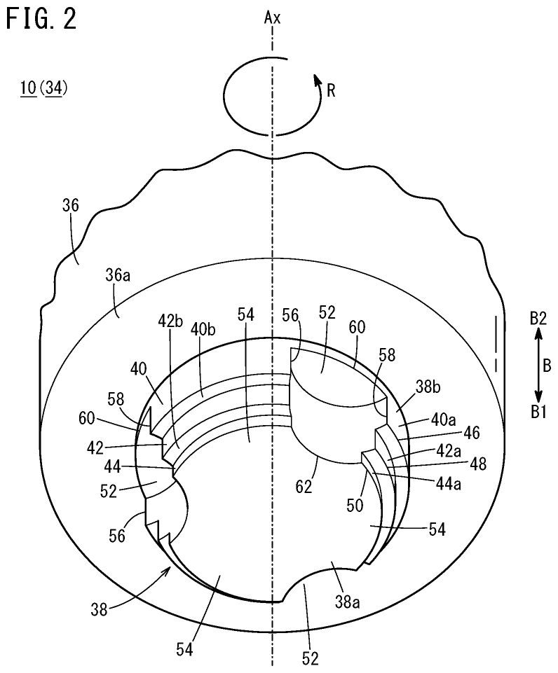

The drive unit 24 includes a rotary motor 28 for rotating the welding tool 10 attached to the chuck 26 in a predetermined rotation direction (in a direction indicated by an arrow R in FIG. 2), and an actuator 30 for moving the welding tool 10 back and forth in a direction of a rotation axis Ax (in a direction indicated by an arrow B in FIG. 2). At the time of performing friction stir welding of the workpiece W, the receiver member 27 is positioned opposite to the chuck 26 (welding tool 10) such that the workpiece W is positioned between the receiver member 27 and the chuck 26. The receiver member 27 receives a pressing force (pressure force) applied from the welding tool 10 to the workpiece W.

The welding tool 10 includes a substantially hollow-cylindrical holder 32 and a tool 34 detachably attached to the holder 32. The proximal end of the holder 32 is clamped by the chuck 26. The tool 34 can be attached to a front end of the holder 32 coaxially with the holder 32. The tool 34 is consumable. When the tool 34 is worn out as a result of friction stir welding, the tool 34 is replaced with new one.

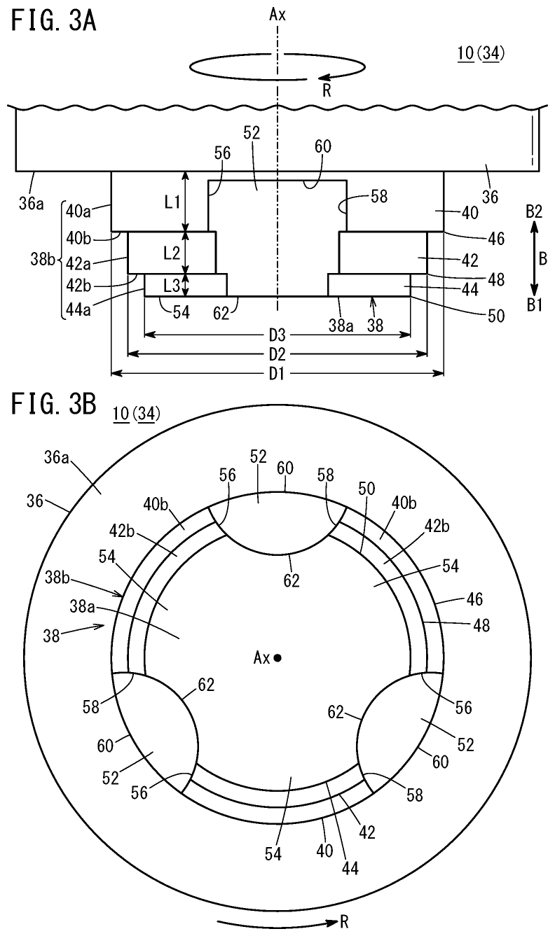

As shown in FIGS. 2 to 3B, the tool 34 includes a substantially cylindrical shoulder 36, and a small diameter probe 38 provided on a front end surface 36a of the shoulder 36. The welding tool 10 welds the workpiece W by rotating the probe 38 in the direction indicated by the arrow R about the rotation axis Ax and embedding the probe 38 inside the workpiece W during rotation of the probe 38.

The tool 34 is produced by machining (cutting) cylindrical metal material. It should be noted that the tool 34 may be produced by a method other than machining (e.g., by means of casting, stacking, etc.). Examples of materials suitably employed in the tool 34 includes tool steels having hardness higher than that of the workpiece W, and having excellent heat resistance and wear resistance. It should be noted that the materials of the tool 34 are not limited to the tool steels, and can be determined as necessary.

The proximal end (end in a direction indicated by an arrow B2) of the shoulder 36 is detachably attached to the holder 32 (see FIG. 1). The front end surface 36a of the shoulder 36 (end surface in a direction indicated by an arrow B1) has a flat shape (see FIGS. 2 and 3A).

The probe 38 protrudes from the front end surface 36a of the shoulder 36 in a front end direction (indicated by an arrow B1) (see FIGS. 2 and 3A). The probe 38 is provided coaxially with the shoulder 36. The outer diameter and the protruding length of the probe 38 can be determined as necessary depending of the shape, the size, the material, etc. of the workpiece W as a welding target.

The probe 38 has a cylindrical shape, and includes a front end surface 38a and an outer circumferential surface 38b. The front end surface 38a of the probe 38 is a flat surface. It should be noted that a recess depressed in a proximal end direction (in a direction indicated by an arrow B2) may be formed in the front end surface 38a of the probe 38.

The probe 38 includes a first part 40 protruding in a cylindrical manner from the front end surface 36a of the shoulder 36 in the front end direction, a second part 42 protruding in a cylindrical manner from a front end surface of the first part 40 in the front end direction, and a third part 44 protruding in a cylindrical manner from the front end surface of the second part 42 in the front end direction.

In FIG. 3A, the diameter of the first part 40 (first outer diameter D1), the diameter of the second part 42 (second diameter D2), and the diameter of the third part 44 (third diameter D3) are determined to satisfy the relationship of: D1>D2>D3. Stated otherwise, the second outer diameter D2 is smaller than the first outer diameter D1, and the third outer diameter D3 is smaller than the second outer diameter D2.

The difference between the first outer diameter D1 and the second outer diameter D2 is the same as the difference between the second outer diameter D2 and the third outer diameter D3. It should be noted that the difference between the first outer diameter D1 and the second outer diameter D2 may be larger than, or may be smaller than the difference between the second outer diameter D2 and the third outer diameter D3. Specific numeric values of the first outer diameter D1, the second outer diameter D2, and the third outer diameter D3 can be determined as necessary depending on the size, the shape, the material, etc. of the workpiece W.

As shown in FIGS. 2 to 3B, a plurality of side surfaces (a first side surface 40a, a second side surface 42a, a third side surface 44a), and a plurality of steps (a first step 40b, a second step 42b) are formed in the outer circumferential surface 38b of the probe 38. The first side surface 40a forms an outer circumferential surface of the first part 40. The first side surface 40a extends from the front end surface 36a of the shoulder 36 up to the front end of the first part 40 along the rotation axis Ax of the probe 38.

The first step 40b forms a front end surface of the first part 40. The first step 40b is coupled to a front end (end in the direction indicate by the arrow B1) of the first side surface 40a. The first step 40b extends in an annular shape in the circumferential direction of the first part 40. The first step 40b is a flat surface extending in a direction perpendicular to the rotation axis Ax of the probe 38. A first edge 46 (first corner) is provided at a border between the first side surface 40a and the first step 40b. The first edge 46 forms an outer marginal portion at the front end of the first part 40.

The second side surface 42a forms an outer circumferential surface of the second part 42. The second side surface 42a extends from an inner end (end closer to the rotation axis Ax) of the first step 40b up to a front end of the second part 42 along the rotation axis Ax of the probe 38. The second step 42b forms a front end surface of the second part 42. The second step 42b is coupled to a front end (end in the direction indicated by the arrow B1) of the second side surface 42a. The second step 42b extends in an annular manner in the circumferential direction of the second part 42. The second step 42b is a flat surface extending in a direction perpendicular to the rotation axis Ax of the probe 38. A second edge 48 (second corner) is provided at a border between the second side surface 42a and the second step 42b. The second edge 48 forms an outer marginal portion at the front end of the second part 42.

The third side surface 44a forms an outer circumferential surface of the third part 44. The third side surface 44a extends from an inner end (end closer to the rotation axis Ax) of the second step 42b up to the front end surface 38a of the probe 38 along the rotation axis Ax of the probe 38. A third edge 50 (third corner) is provided at a border between the third side surface 44a and the front end surface 38a of the probe 38. The third edge 50 forms an outer marginal portion at the front end of the probe 38 (third part 44).

In FIG. 3A, the first length L1 in the first side surface 40a along the rotation axis Ax of the probe 38 corresponds to the protruding length of the first part 40. The second length L2 in the second side surface 42a along the rotation axis Ax of the probe 38 corresponds to the protruding length of the second part 42. The third length L3 in the third side surface 44a along the rotation axis Ax of the probe 38 corresponds to the protruding length of the third part 44. The first length L1, the second length L2, and the third length L3 are determined to satisfy the relationship of: L1>L2>L3. Stated otherwise, the second length L2 is smaller than the first length L1, and the third length L3 is smaller than the second length L2.

That is, the first length L1, the second length L2, and the third length L3 are determined in a manner that, among the first side surface 40a, the second side surface 42a, and the third side surface 44a, the one closer to the front end of the probe 38 has the smaller length. Specific numeric values of the first length L1, the second length L2, and the third length L3 can be determined as necessary depending on the size, the shape, the material, etc. of the workpiece W.

As shown in FIGS. 2 to 3B, a plurality of (three, in the illustrated embodiment) outer circumferential recesses 52 extending up to the front end surface 38a along the rotation axis Ax of the probe 38 are formed in the outer circumferential surface 38b of the probe 38. The plurality of outer circumferential recesses 52 are arranged at equal intervals of angle (at intervals of 120°, in the illustrated embodiment) in a circumferential direction of the probe 38 (see FIGS. 2 and 3B). The proximal end of each of the outer circumferential recesses 52 is positioned adjacent to the proximal end of the probe 38.

The probe 38 has claws 54 between the outer circumferential recesses 52 that are adjacent to each other in the circumferential direction of the probe 38. Stated otherwise, the number of the claws 54 of the probe 38 corresponds to the number of the outer circumferential recesses 52. The first part 40, the second part 42, and the third part 44 are formed in each of the claws 54.

In FIGS. 2 and 3A, a first outer circumferential edge 56, a second outer circumferential edge 58, and a third outer circumferential edge 60 are formed in the outer circumferential surface 38b of the probe 38. The first outer circumferential edge 56 forms a marginal portion on the front side in the rotation direction of the probe 38 (indicated by an arrow R) in each of the outer circumferential recesses 52. The proximal end of the first outer circumferential edge 56 (one end in the direction indicated by the arrow B2) is positioned adjacent to the proximal end of the probe 38. The front end of the first outer circumferential edge 56 (the other end in the direction indicated by the arrow B1) is positioned at the front end surface 38a of the probe 38.

The second outer circumferential edge 58 forms a marginal portion on the rear side in the rotation direction of the probe 38 (direction opposite to the direction indicated by the arrow R) in each of the outer circumferential recesses 52. The proximal end of the second outer circumferential edge 58 (one end in the direction indicated by the arrow B2) is positioned adjacent to the proximal end of the probe 38. The front end of the second outer circumferential edge 58 (the other end in the direction indicated by the arrow B1) is positioned on the front end surface 38a of the probe 38.

The third outer circumferential edge 60 forms a marginal portion of each of the outer circumferential recesses 52 in the proximal end direction of the probe 38 (indicated by the arrow B2). The third outer circumferential edge 60 couples the proximal end of the first outer circumferential edge 56 and the proximal end of the second outer circumferential edge 58 together. The third outer circumferential edge 60 extends in the circumferential direction of the probe 38.

In FIGS. 2 to 3B, a front end edge 62 is formed in the front end surface 38a of the probe 38. The front end edge 62 forms a front end marginal portion of the outer circumferential recess 52. The front end edge 62 couples the front end of the first outer circumferential edge 56 and the front end of the second outer circumferential edge 58 together. The front end edge 62 is curved in a circular arc shape in a manner that the arc is convex toward the rotation axis Ax of the probe 38 (convex inward). The radius of curvature of the front end edge 62 can be determined as necessary. The front end edge 62 may extend straight from the front end of the first outer circumferential edge 56 to the front end of the second outer circumferential edge 58.

The first edge 46 and the second edge 48 are coupled to intermediate positions of the first outer circumferential edge 56 and the second outer circumferential edge 58, respectively. The third edge 50 is coupled to the front ends of the first outer circumferential edge 56 and the second outer circumferential edge 58, respectively.

Next, an example of lap welding the first member 100 (e.g., iron plate) and the second member 102 (aluminum alloy plate) of the workpiece W together using the above described welding tool 10 will be described.

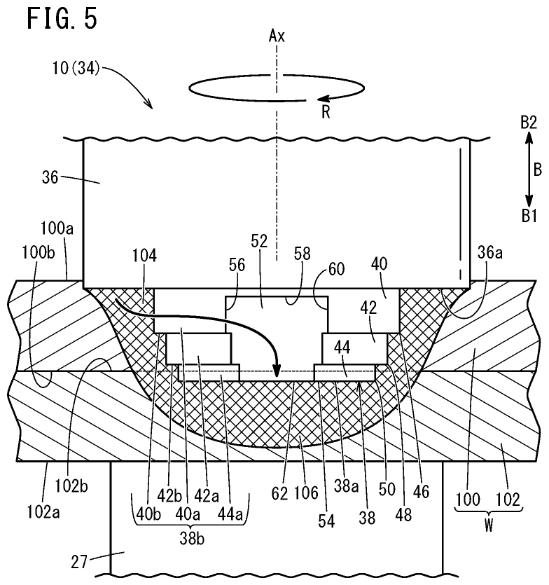

In this case, in FIG. 1, in the state where the first member 100 and the second member 102 are stacked together, the workpiece W is fixed to the fixing base 13. Specifically, as shown in FIGS. 4 and 5, one surface (first outer surface 100a) of the first member 100 is oriented toward the shoulder 36. The other surface (first inner surface 100b) of the first member 100 contacts one surface (second inner surface 102b) of the second member 102. The other surface (second outer surface 102a) of the second member 102 contacts the receiver member 27.

Then, the control unit 20 controls driving of the drive unit 24 to move the welding tool 10 toward the workpiece W (in the direction indicated by the arrow B1) while rotating the welding tool 10, and presses the front end surface 38a of the probe 38 against the first outer surface 100a of the first member 100.

As a result, as shown in FIG. 5, the probe 38 is inserted into the first member 100 while the probe 38 is machining the first member 100. At this time, since frictional heat is produced between the probe 38 and the first member 100, the portion of the first member 100 around the probe 38 is softened.

Then, when the front end surface 38a of the probe 38 reaches the second inner surface 102b of the second member 102, the probe 38 is inserted into the second member 102 while machining the second member 102. At this time, since frictional heat is produced between the probe 38 and the second member 102 and the frictional heat produced in the first member 100 is transmitted to the second member 102, the portion of the second member 102 around the probe 38 is softened. Then, the probe 38 is embedded in the workpiece W completely, and the front end surface 36a of the shoulder 36 is brought into contact with the first outer surface 100a of the first member 100.

The softened portion of the first member 100 (first softened material 104) and the softened portion of the second member 102 (second softened material 106) are dragged by rotation of the probe 38 to flow plastically, and stirred together (mixed together).

Specifically, in the embodiment of the present invention, frictional heat is generated efficiently between each of the first edge 46, the second edge 48, and the third edge 50 and the workpiece W. Further, the probe 38 machines, and stirs the workpiece W by the first edge 46, the second edge 48, and the third edge 50. In particular, the probe 38 machines, and stirs the workpiece W effectively by the borders (corners) between each of the first edge 46, the second edge 48, and the third edge 50 and the second outer circumferential edge 58 effectively.

When the probe 38 is rotated, the first softened material 104 positioned on the lateral side of the probe 38 is taken into the outer circumferential recesses 52, and flows plastically in the front end direction of the probe 38. As a result, the first softened material 104 and the second softened material 106 are stirred together in the front end direction of the probe 38.

Then, as shown in FIG. 4, by moving the welding tool 10 in the welding direction (in the direction indicated by an arrow F) while maintaining rotation and pressing of the welding tool 10, the first member 100 and the second member 102 are welded together integrally by friction stir welding. As a result, a joint portion 108 (joint bead) is formed in the workpiece W.

In this case, the welding tool 10 according to the embodiment of the present invention offers the following advantages.

The first step 40b and the second step 42b are formed in the outer circumferential surface 38b of the probe 38 in a manner that the probe 38 is narrowed stepwise toward its front end.

In the structure, since the first edge 46 and the second edge 48 are formed in the outer circumferential surface 38b of the probe 38, it is possible to efficiently generate friction heat between each of the first edge 46 and the second edge 48 and the workpiece W. Further, it is possible to efficiently machine and stir the workpiece W by the first edge 46 and the second edge 48. Accordingly, it is possible to achieve the suitable welding quality.

The first side surface 40a, the second side surface 42a, and the third side surface 44a extending along the rotation axis Ax of the probe 38 are formed in the outer circumferential surface 38b of the probe 38. The first side surface 40a continues to the first step 40b, the second side surface 42a continues to the first step 40b and the second step 42b, and the third side surface 44a continues to the second step 42b. The length of the first side surface 40a, the length of the second side surface 42a, and the length of the third side surface 44a along the rotation axis Ax are determined in a manner that, among the first side surface 40a, the second side surface 42a, and the third side surface 44a, the one closer to the front end of the probe 38 has the smaller length.

In the structure, it is possible to improve the heat generation efficiency, the machining efficiency, and stirring efficiently of the probe 38 effectively. Further, it is possible to increase the rigidity on the proximal end side of the probe 38.

Each of the first step 40b and the second step 42b extends in a direction perpendicular to the rotation axis Ax. In the structure, since it is possible to make the angle of the first edge 46 and the angle of the second edge 48 comparatively small, it is possible to improve the machining efficiency.

### First Embodiment

Next, a probe 38A according to a first modified embodiment will be described. In the description of the probe 38A, constituent elements having the structure identical to that of the probe 38 are labeled with the same reference numerals, and description thereof is omitted. Further, in the probe 38A, the structure similar to that of the probe 38 offers similar effects and advantages. Also in a probe 38B according to a second modified embodiment and a probe 38C according to a third modified embodiment, constituent elements having the structure identical to that of the probe 38 are labeled with the same reference numerals, and description thereof is omitted, and the structure similar to that of the probe 38 offers similar effects and advantages.

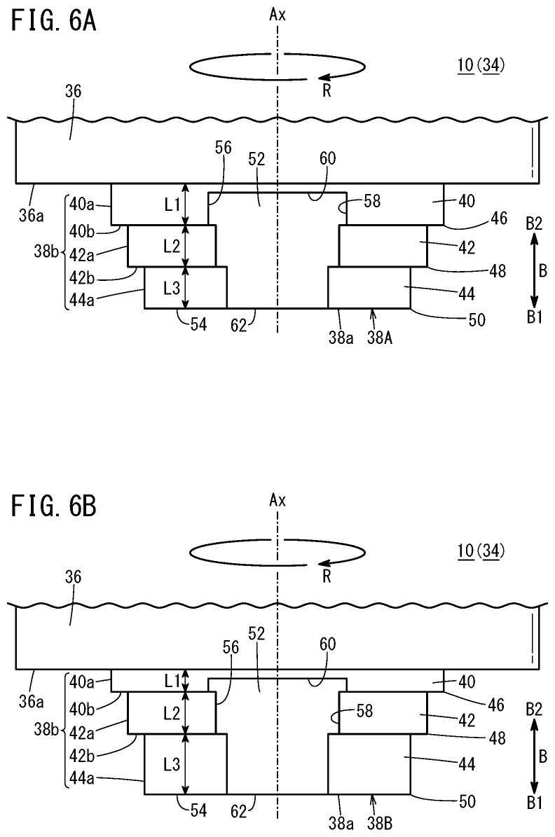

As shown in FIG. 6A, in the probe 38A, the first length L1, the second length L2, and the third length L3 are determined to satisfy the relationship of: L1=L2=L3. That is, all of the first length L1, the second length L2, and the third length L3 are the same. The meaning of the “same” herein includes the case where the first length L1, the second length L2, and the third length L3 are substantially the same, even though the length may vary due to machining tolerance.

In this modified embodiment, it is possible to distribute the stress applied to the probe 38 (it is possible to avoid stress concentration). Therefore, it is possible to improve the durability of the probe 38A. Further, in the direction along the rotation axis Ax of the probe 38A, it is possible to achieve uniform stirring performance.

### Second Embodiment

Next, the probe 38B according to the second modified embodiment will be described. As shown in FIG. 6B, in the probe 38B, the first length L1, the second length L2, and the third length L3 are determined to satisfy the relationship of: L1<L2<L3. Stated otherwise, the second length L2 is larger than the first length L1, and the third length L3 is larger than the second length L2. That is, the first length L1, the second length L2, and the third length L3 are determined in a manner that, among the side surfaces, the one closer to the front end of the probe 38 has the larger length.

In this modified embodiment, it becomes easier to insert the probe 38B into the workpiece W.

### Third Embodiment

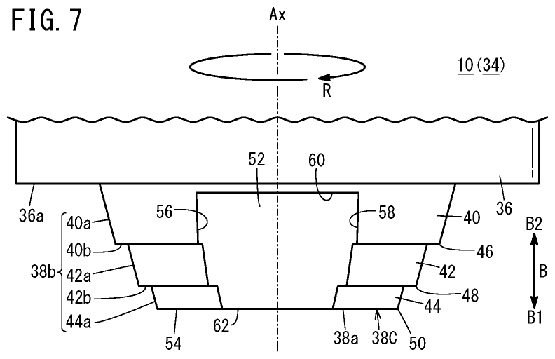

Next, the probe 38C according to the third modified embodiment will be described. As shown in FIG. 7, the probe 38C extends in a tapered manner such that each of the first side surface 40a, the second side surface 42a, and the third side surface 44a is inclined toward the rotation axis Ax, in the front end direction, i.e., toward the front end of the probe 38C (inward in the radial direction of the probe 38C).

In this modified embodiment, it becomes much easier to insert the probe 38C into the workpiece W. Further, it is possible to make the angle of each of the first edge 46, the second edge 48, and the third edge 50 relative large (e.g., obtuse angle). In this manner, it is possible to increase the rigidity (strength) of each of the first edge 46, the second edge 48, and the third edge 50.

The shapes of the first side surface 40a, the second side surface 42a, and the third side surface 44a of the probe 38C according to the third modified embodiment are applicable to the above described probes 38A, 38B as well.

The present invention is not limited to the above described embodiments. It is a matter of course that various modifications may be made without departing from the gist of the present invention.

One step or three or more steps may be formed in the outer circumferential surface 38b of the probe 38, 38A, 38B, or 38C. As the number of the steps increases, the number of edges increases, and thus, heat generation performance, the machining performance, and the stirring performance are improved. The welding tool 10 may be configured to perform lap welding of a workpiece W which comprises three or more plate members that are stacked together. The welding tool 10 may be used in butt welding, where end surfaces of two plate members are brought into abutment with each other, and the abutting portions are welded together by friction stir welding. The number of outer circumferential recesses 52 may be one, two, or four or more in the probe 38, 38A, 38B, or 38C. Further, in the welding tool 10, the outer circumferential recess 52 may not be provided in the probe 38, 38A, 38B, or 38C.

The above embodiments are summarized as follows:

The above embodiments disclose the friction stir welding tool (10) configured to rotate the probe (38, 38A, 38B, 38C) about the rotation axis (Ax), and embed the probe (38, 38A, 38B, 38C) inside the workpiece (W) during rotation of the probe (38, 38A, 38B, 38C) from the front end of the probe to weld the workpiece (W), wherein the step (40b, 42b) is formed in the outer circumferential surface (38b) of the probe (38, 38A, 38B, 38C) in a manner that the probe (38, 38A, 38B, 38C) is narrowed stepwise toward the front end of the probe (38, 38A, 38B, 38C).

In the above described friction stir welding tool (10), the plurality of side surfaces (40a, 42a, 44a) may be formed in the outer circumferential surface (38b) of the probe (38) and the side surfaces (40a, 42a, 44a) may extend along the rotation axis (Ax) and continue to the step (40b, 42b), and the lengths (L1, L2, L3) of the plurality of side surfaces (40a, 42a, 44a) along the rotation axis (Ax) may be configured to be smaller as the side surfaces (40a, 42a, 44a) are closer to the front end of the probe (38).

In the above described friction stir welding tool (10), the plurality of side surfaces (40a, 42a, 44a) may be formed in the outer circumferential surface (38b) of the probe (38A) and the side surfaces (40a, 42a, 44a) may extend along the rotation axis (Ax) and continue to the step (40b, 42b), and all of the plurality of side surfaces (40a, 42a, 44a) may be configured to have the same length (L1, L2, L3) along the rotation axis (Ax).

In the above described friction stir welding tool (10), the plurality of side surfaces (40a, 42a, 44a) may be formed in the outer circumferential surface (38b) of the probe (38B), and the side surfaces (40a, 42a, 44a) may extend along the rotation axis (Ax) and continue to the step (40b, 42b), and the lengths (L1, L2, L3) of the plurality of side surfaces (40a, 42a, 44a) along the rotation axis (Ax) may be configured to be larger as the side surfaces (40a, 42a, 44) are closer to the front end of the probe (38B).

In the above described friction stir welding tool (10), the step (40b, 42b) may extend in a direction perpendicular to the rotation axis (Ax).

What is claimed is:

1. A friction stir welding tool configured to rotate a probe about a rotation axis, and embed the probe inside a workpiece during rotation of the probe from a front end of the probe to weld the workpiece,
wherein a step is formed in an outer circumferential surface of the probe in a manner that the probe is narrowed stepwise toward the front end of the probe.

2. The friction stir welding tool according to claim 1, wherein a plurality of side surfaces are formed in an outer circumferential surface of the probe, and the side surfaces extend along the rotation axis and continue to the step; and
lengths of the plurality of side surfaces along the rotation axis are configured to be smaller as the side surfaces are closer to the front end of the probe.

3. The friction stir welding tool according to claim 1, wherein a plurality of side surfaces are formed in an outer circumferential surface of the probe, and the side surfaces extend along the rotation axis and continue to the step; and
all of the plurality of side surfaces are configured to have same length along the rotation axis.

4. The friction stir welding tool according to claim 1, wherein a plurality of side surfaces are formed in an outer circumferential surface of the probe, and the side surfaces extend along the rotation axis and continue to the step; and
lengths of the plurality of side surfaces along the rotation axis are configured to be larger as the side surfaces are closer to the front end of the probe.

5. The friction stir welding tool according to claim 1, wherein the step extends in a direction perpendicular to the rotation axis.
